(19) United States
(12) Patent Application Publication
(10) Pub. No.: US 2005/0282976 A1
(43) Pub. Date: Dec. 22, 2005

(54) Silicone epoxy formulations

(75) Inventors: Deborah Ann Haitko, Schenectady, NY (US); Donald Buckley JR., Schenectady, NY (US)

Correspondence Address: Scott A. McCollister, Esq.;Fay, Sharpe, Fagan, Minnich & McKee, LLP, Seventh Floor, 1100 Superior Avenue, Cleveland, OH, 44114-2518, US

(73) Assignee: GELcore LLC.

(21) Appl. No.: 10/874,078

(22) Filed: Jun. 22, 2004

(51) Int. Cl. C08L 83/00

(52) U.S. Cl. 525/476

(57) ABSTRACT

An encapsulant composition is provided. The composition includes an epoxy composition including at least two siloxane repeat units and a curing agent. The encapsulant composition is particularly suited for encapsulating light emitting diode components.

### BACKGROUND OF THE INVENTION

This invention relates to light emitting devices including a light emitting diode in combination with a phosphor material. Light emitting diodes (LEDs) are well-known solid-state devices that can generate light having a peak wavelength in a specific region of the visible spectrum. Early LEDs emitted light having a peak wavelength in the red region of the light spectrum, and were often based on aluminum, indium, gallium and phosphorus semiconducting materials. More recently, LEDs based on Group III-nitrides where the Group III element can be any combination of Ga, In, Al, B, and Ti, have been developed that can emit light having a peak wavelength in the green, blue and ultraviolet regions of the spectrum. The present invention relates to an epoxy-based encapsulant formulation for lighting devices. As one example, the present invention relates to an encapsulant formulation for light emitting diodes.

An epoxy for this type of application should be homogenous, flexible, and optically transparent. The epoxies must also be able to withstand thermal shock testing. Current epoxies useful in encapsulant formulations may withstand thermal shock testing, but fall short in terms of optical transparency over extended use. Moreover, these formulations may degrade after extended use, or can develop cracks or peeling of the binder from the substrate of the lighting device.

It would therefore be desirable to develop an encapsulant material that is able to withstand thermal shock while maintaining optical transparency over a period of extended use. Additionally, improved flexibility in an encapsulant would lead to reduced stress in the device due to the coefficient of thermal expansion between the inorganic chip and packaging and an organic encapsulant.

### SUMMARY OF THE INVENTION

According to one aspect of the invention, an encapsulant composition is provided. The composition includes an epoxy composition including at least two repeat siloxane units, and a curing agent. Preferably, the composition will include greater than two repeat units.

In another embodiment a method for forming an encapsulant composition is provided. The method includes the step of mixing together an epoxy composition including at least two repeat units, and a curing agent.

In a third embodiment a lamp is provided. The lamp includes an encapsulant composition comprised of an epoxy composition including at least two siloxane repeat units, at least partially surrounding an LED.

### BRIEF DESCRIPTION OF THE DRAWINGS

FIG. 1 is a schematic sectional view of a lamp employing the encapsulant material of the present invention.

### DETAILED DESCRIPTION OF THE INVENTION

An epoxy based composition has been developed for various applications. One particular use is for encapsulating high density interconnected multichip modules. The epoxy resin composition of the present invention preferably comprises an epoxy resin, and a curing agent. Optionally, the composition may also include a filler, provided such filler has a particle size less than 400 nm. The resin is suitable for use as an encapsulant material in lighting devices.

Exemplary resins include epoxies with more than two siloxane repeat units. Preferred resins include between about two and about 15 repeat units, more preferably between about three and ten repeat units. As more repeat units are added to the composition, the adhesion of the resin decreases. If the number of siloxane repeat units is greater than about 15, then the composition behaves more like a silicone and less like an epoxy, resulting in poor adhesion and inefficiency of the composition as an encapsulant. However, it is envisioned that adhesion promoters could be added to the composition to compensate.

The siloxane repeat units are preferably substituted. Preferred substituents include cycloaliphatic groups, cycloaliphatic epoxy groups, glycidoxy groups, and mixtures thereof. Cycloaliphatic groups are especially preferred to the their resistance to thermal and photo aging. Preferred cylcoaliphatic groups include materials derived from vinylcyclohexene-1,2-diepoxide, and mixtures thereof.

In an especially preferred resin, the siloxane chain length of 1,3-bis(1,2-epoxy-4-cyclohexylethyl)-1,1,3,3-tetramethyl disiloxane is increased to greater than two dimethylsiloxane repeat units. The advantage of such a resin includes increased flexibility that provides decreased stress within the lighting device.

A curing agent is preferably added to the present composition. The curing agent is preferably a multifunctional organic compound capable of reacting with the epoxy functionalities located within the composition. Suitable curing agents include resins obtained by the condensation or co-condensation of phenols (e.g. phenol, cresol, resorcin, catechol, bisphenol A and bisphenol F) and/or naphthols (e.g., α-naphthlol, β-naphthol, and dihydroxynaphthalene) with aldehydes such as formaldehyde in the presence of an acid catlyst; aralkyl type phenolic resins (e.g., phenol-aralkyl resins and naphthol-aralkyl resins); and mixtures thereof. Other preferred curing agents include amines, amides, phenols, thiols, carboxylic acids, carboxylic anhydrides, alkyl sulfonium salts and mixtures thereof. The most preferred curing agents are anhydrides, and exemplary curing agents include cis-1,2-cyclo hexane dicarboxylic anhydride, methylhexohydropthalic anhydride, and mixtures thereof.

The curing agent is preferably mixed in such an amount that the equivalent weight of phenolic hydroxyl groups is from about 0.5 to about 1.5 equivalent weight, and more preferably from about 0.8 to about 1.2 equivalent weight, the epoxy resin may cure insufficiently to tend to make the cured product have poor heat resistance, moisture resistance, and electrical properties. If it is more than about 1.5 equivalent weight, the curing agent constituent is present in excess, so that the phenolic hydroxyl groups may remain in a large quantity in the cured-product resin. This could result in poor electrical properties and moisture resistance.

A curing accelerator may also be preferably mixed with the resin of the present invention to accelerate the etherification reaction of epoxy groups with phenolic hydroxyl groups. Preferred curing accelerators include tertiary amines, such as 1,8-diazabicyclo[5.4.0]undecene-7,1,5-diazabicyclo[5.4.0]nonene, 5,6-dibutylamino-1,8-diazabicyclo[5.4.0]undecene-7, benzyldimethylamine, triethanolamine, dimethylaminoethanol and tris(dimethylaminomethyl)phenol; imidazoles, such as 2-methylimidazole, 2-phenylimidazole, and 2-phenyl-4-methylimidazole; organophosphines, such as tributylphosphine, methyldiphenylphosphine, triphenylphosphine, diphenylphosphine, and phenylphosphine; phophorus coumounds having intramolecular polarization, including any of the above organophosphines to which a compound having a π-bond such as maleic anhydride, benzoquinone, or diazophenylmethane has been added; tetraphenyl phophonium tetraphenylborate, triphenylphosphine tetraphenylborate, 2-ethyl-4-methylimidazole tetraphenylbborate, N-methyltetraphenylphosphonium tetraphenylborate, triphenylphosphonium triphenylborate, alkyl sulfonium salts and mixtures thereof.

The curing accelerator may preferably be mixed in an amount of from about 0.01 to 5 parts by weight, and more preferably from about 0.1 to about 3 parts by weight, based on 100 parts by weight of the epoxy resin.

In non-lamp applications for the present composition, where light transmission is not important, a filler, such as a non-conductive carbon, may also be included. Preferred non-conductive carbons include non-conductive polymer baked carbon obtained by baking a polymer; graft carbon obtained by grafting a polymer onto the particle surfaces of carbon black; a carbon-included filler obtained by covering surfaces of carbon black with an insulating inorganic matter such as silica; carbon black having been subjected to surface treatment; non-conductive carbons coated with epoxy resin, phenolic resin or the like; and mixtures thereof. An additional filler, such as an inorganic filler, may also be included in the composition. Preferred fillers include powders of fused silica, crystalline silica, alumina, zircon, calcium silicate, calcium carbonate, silicon carbide, boron nitride, beryllia and zirconia, or beads of any of these made spherical; single-crystal fibers of potassium titante, silicon carbide, silicon nitride and alumina, or glass fibers; inorganic fillers having a flame-retardant effect, such as aluminum hydroxide and zinc borate, and mixtures thereof.

While a filler is most likely avoided in applications in which light transmission is important, a filler or material functionalized to a particle having a size less than about 400 nm may be employed.

A coupling agent may also be added to the epoxy resin composition. The inclusion of a coupling agent may improve the affinity of the filler for the resin constituent. Coupling agents commonly used in the art may be selected. Preferred coupling agents include silane type coupling agents such as vinyltrichlorosilane, vinyltriethoxysilane, vinyltris(β-methoxyethyoxy) silane, γ-methacryloxypropyltrimethoxysilane, β-(3,4-epoxydicyclohexyl)ethyltrimethoxysilane, γ-glycidoxypropyltrimethoxysilane, vinlytriacetoxysilane, γ-mercaptopropyltirmethoxysilane, γ-aminopropyltriethoxysilane, γ-[bis-(β-hydroxyethyl)]aminopropyltriethoxysilane, N-β-(aminoethyl)-γ-aminopropyltrimethoxysilane, γ-(β-aminoethyl)aminopropyldimethoxymethylsilane, N-(trimethoxysiliylpropyl)ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltrimethoxysilaen, vinyltrimethoxysilane and γ-mercaptopropylmethyldimethoxysilane; titanate type coupling agents such as isopropyltriisosteroyl titanate, isopropyltris(diocyl pyrophosphate) titanate, isoprpyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isoprpyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisoprpylbis (dioctyl phosphite) titanate; and mixtures thereof.

Bonding enhancers can be added to the present adhesive composition to improve the interaction of the components within the composition. Preferred bonding enhancers are multifunctional epoxies. More preferably, the bonding enhancers are epoxies with at least about 3 epoxy moieties within the compound. Exemplary bonding enhancers include N,N′-diglycidyl-p-aminophenyl-glycidyl ether, triglycidyl p-aminophenol derived resins, 1,3,5-triglycidyl isocyanurate, tetraglycidylmethylenedianiline, and glycidyl ether of novolac epoxies. The bonding enhancers are preferably added to the present composition in an amount between about 3 and 30% by weight of the total composition, more preferably between about 9 and 26 wt %.

Hardeners may also be added to the present adhesive composition to improve the curing reaction. Preferred hardeners are amine hardeners. Exemplary amine hardeners include isophoronediamine, triethylenetetraamine, diethylenetriamine, aminoethylpiperazine, 1,2- and 1,3-diaminopropane, 2,2-dimethylpropylenediamine, 1,4-diaminobutane, 1,6-diaminohexane, 1,7-diaminoheptane, 1,8-diaminooctane, 1,9-diaminononae, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4- and 2,4,4-trimethylhexamethylenediamine, 1,2- and 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-dimino-cyclohexane, 4,4′-dimiondicyclohexylmethane, 4,4′-diaminodicyclohexylpropane, 2,2-bis(4-aminocyclohexyl)propane, 3,3′-dimethyl-4,4′diamiondicyclohexylmethane, 3-amino-1-cyclohexaneaminopropane, 1,3- and 1,4-bis(aminomethyl)cyclohexane, m- and p-xylylendiamine, and mixtures thereof. A particularly preferred amine hardeners is melamine formaldehyde. The hardening agent is preferably added to the present adhesive composition in an amount between about 4 and 20 wt % of the total composition, more preferably between about 6 and 15 wt. %.

Flexibilizing components can also be added to the composition to better function as a chip-on-flex adhesive. Preferred flexibilizers contain substantially no carbon. Low carbon content flexibilizers are preferred to limit the later formation of soot if the applied composition is laser ablated. Suitable flexibilizers include silicone polymer additives, including fumed and unfumed silica, alumina polymer additives, including fumed and unfumed alumina, polysulfide rubbers, and mixtures thereof. Flexibilizers typically used in polyurethane systems are also suitable. Flexibilizers are preferably added to the present adhesive composition in an amount between about 3 and 20 wt % of the total composition, more preferably between about 5 and 10 wt %.

Additional additives known in the art may also be added to the present epoxy composition. For example, a release agent such as a higher fatty acid (e.g., carnauba wax or a polyethylene type wax), a modifier such assilcone oil or silicone rubber, an ion trapper such as hydrotalcite or antimony-bismuth and mixtures thereof may optionally be mixed as other additives.

In the encapsulant epoxy resin composition for non-lamp applications, at least one colorant may further be used. The colorants are exemplified by azine dyes, anthraquinone dyes, disazo dyes, diiminium dyes, aminium duyes, diimonium dyes, Cr complexes, Fe complexes, Co complexes, Ni complexes, Fe, cu, Ni, and the like metal compounds, Al, Mg, Fe, and the like metal oxides, mica, near infrared absorbers, phthalocyanine pigments, phthalocyanine dyes, carbon black, and mixtures thereof. In particular, phthalocyanine dyes may be advantageous in view of their laser markability, flowability, and curability.

The encapsulant epoxy resin composition of the present invention may be prepared by methods known in the art as long as the constituent materials can uniformly be dispersed and mixed. As a commonly available method, the constituent materials are thoroughly mixed by a mixer and thereafter melt-kneaded by a heat roller or extruder, followed by cooling and pulverization. It may be preferred to mold the product thus obtained into tablets in such a size and weight that may suit molding conditions.

The curing reaction of the present composition is can be carried out by the addition of a catalyst. Preferred catalysts are substances that contain an unshared pair of electrons in an outer orbital, including Lewis Bases such as tertiary amines, imidazoles, and imidazolines. Similarly, an alkyl sulfonium salt can be used. Exemplary catalysts include 2-ethyl-4-methyl-imidazole, N-(3-aminopropyl) imidazole, 2-phenyl-2-imidazoline, and mixtures thereof. The selected catalysts are added to the present composition in an amount between about 0.05 and 1.0 wt % of the total composition, more preferably between about 0.1 and 0.3 wt %.

A tackifier may be added to the present composition. The tackifier can be added to improve thermal resistance. Preferred tackifiers are thermoset resins such as phenolics and melamines. Especially preferred tackifiers are carboxyl terminated compounds. Exemplary tackifying agents include melamine formaldehyles, urea formaldehydes, phenol formaldehydes, epoxidized ortho cresol novolacs, and mixtures thereof. Tackifiers can be added to the present composition in an amount between about 5 and 20 wt % of the total composition, more preferably between about 6 and 15 wt %.

While the present invention is suited for use with any type of light emitting device including those emitting red and yellow regions, it may be particularly beneficially when used with LEDs emitting in the green blue and/or UV regions where phosphor conversion is usually employed. Representative examples of green blue and/or UV emitting LEDs are those referred to as gallium nitride based.

One exemplary type of LED design provided for demonstration purposes only is the following: the materials made of AlₓGa_{y}In_{(1-x-y)}N where both X and Y is between 0 and 1(0≦X≦1, 0≦Y≦1) and wherein a narrower bandgap GaN-based light-emitting structure is sandwiched between single or multiple layers of wider bandgap GaN-based structures with different conductivity types on different sides of the light-emitting structure.

Of course, the present invention is not limited thereto. Moreover, the present invention is believed beneficial with LEDs of any construction and, particularly those where a relatively thick substrate is utilized. Accordingly, the present invention can function with radiation of any wavelength provided phosphor compatibility exists. Similarly, the present invention is compatible with double heterostructure, multiple quantum well, single active layer, and all other types of LED designs. For example, the LED may contain at least one semiconductor layer based on GaN, ZnSe or SiC semiconductors. The LED may also contain one or more quantum wells in the active region, if desired. Typically, the LED active region may comprise a p-n junction comprising GaN, AlGaN and/or InGaN semiconductor layers. The p-n junction may be separated by a thin undoped InGaN layer or by one or more InGaN quantum wells.

The present invention can operate with any suitable phosphor material or combinations of phosphor materials. Moreover, provided that a phosphor which is compatible with the selected LED is used, the present invention can improve the device performance. Importantly, this means that no requirement exists in the invention with respect to the wavelength generated by the LED, the wavelength the phosphor excites or re-emits, or at the overall wavelength of light emitted by the light emitting device. Nonetheless, several exemplary phosphor systems are depicted below to facilitate an understanding of the invention.

Conventionally, a blue LED is an InGaN single quantum well LED and the phosphor is a cerium doped yttrium aluminum garnet (“YAG:Ce”), Y3Al5O12:Ce3⁺. The blue light emitted by the LED is transmitted through the phosphor and is mixed with the yellow light emitted by the phosphor. The viewer perceives the mixture of blue and yellow light as white light. One alternative phosphor is a TAG:Ce wherein terbium is substituted for yttrium. Other typical white light illumination systems include a light emitting diode having a peak emission wavelength between 360 and 420 nm, a first APO:Eu²⁺, Mn²⁺ phosphor, where A comprises at least one of Sr, Ca, Ba or Mg, and a second phosphor selected from at least one of:
a) A₄D₁₄O₂₅:Eu²⁺, where A comprises at least one of Sr, Ca, Ba or Mg, and D comprises at least one of Al or Ga;
b) 2AO*0.84P₂O₅*0.16B2O3):Eu²⁺, where A comprises at least one of Sr, Ca, Ba or Mg;
c) AD₈O₁₃:Eu²⁺, where A comprises at least one of Sr, Ca, Ba or Mg and D comprises at least one of Al or Ga;
d) A₁₀(PO₄)₆Cl₂:Eu²⁺, where A comprises at least one of Sr, Ca, Ba or Mg; or
e) A₂Si₃O₈*2ACl₂:Eu²⁺, where A comprises at least one of Sr, Ca, Ba or Mg.

Accordingly, the phosphor system may be a blend of materials. For example, a white light illumination system can comprise blends of a first phosphor powder having a peak emission wavelength of about 570 to about 620 nm and a second phosphor powder having a peak emission wavelength of about 480 to about 500 m to form a phosphor powder mixture adjacent the LED.

Exemplary polymeric fillers include silicones, several examples of which are available from GE-Toshiba Silicones, which can be used interchangeably as the transparent fill layer or as the phosphor dispersion layer. In addition, it is contemplated that the dispersion layer can be phosphor suspension a volatile organic solution such as a low molecular weight alcohol. Advantageously, the filler layer, the phosphor containing layer and the optic lens element can be formed/assembled according to any techniques known to the skilled artisan.

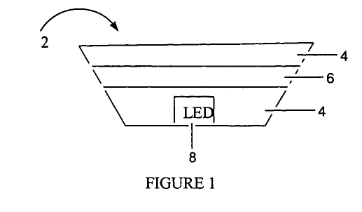

With reference to FIG. 1, a schematic view of a light source 2 is shown. The encapsulant material 4 is located adjacent to a phosphor layer 6. The phosphor layer 6 is excited by, for example, a UV/blue light emitted by the LED 8 and converts that light to visible white light.

Notwithstanding the depicted embodiment, the skilled artisan will recognize that any LED device configuration may be improved by the inclusion of the present inventive encapsulant composition. The embodiment specifically described herein is meant to be illustrative only and should not be construed in any limiting sense.

In the following, the present invention will be described in more detail with reference to non-limiting examples. These examples are for the purposes of illustration only and should not be construed in any limiting sense.

### EXAMPLES

40 grams vinylcyclohexene-1,2-epoxide, 24 grams toluene and 100 ppb of cis-bistriphenylphosphine platinum dichloride were added to a three neck flask equipped with a thermometer, condenser and addition funnel and heated. Once reflux was reached at approximately 130° C., slow addition of 19.8 grams 1,1,2,2,3,3,-hexamethyltrisiloxane was performed. Once addition of 1,1,2,2,3,3,-hexamethyltrisiloxane was complete, the reaction was allowed to reflux for one additional hour. At this time the solvents and excess vinylcyclohexene-1,2-epoxide were removed in vacuo leaving a viscous product, 1,3-bis(1,2-epoxy-4-cyclohexylethyl)-1,1,2,2,3,3-hexamethyldisiloxane.

To facilitate evaluation of the present inventive composition having at least two repeat siloxane units, polymers of the following formula (MeMe)—having alternate epoxy-silane units—were prepared:
MₐM′_{b}D_{c}D′_{d}TₑT′_{f}Q_{g}
Where the subscripts a, b, c, d, e, f and g are zero or a positive integer, subject to the limitation that the sum of the subscripts b, d and f is one or greater; where M has the formula:
R¹₃SiO_{1/2},
M′ has the formula:
(Z)R²₂SiO_{1/2},
D has the formula:
R³₂SiO_{2/2},
D′ has the formula:
(Z)R⁴SiO_{2/2},
T has the formula:
R⁵SiO_{3/2},
T′ has the formula:
(Z)SiO_{3/2},
and Q has the formula SiO_{4/2}, where each R¹, R², R³, R⁴, R⁵ is independently at each occurrence a hydrogen atom, C₁₋₂₂ alkyl, C₁₋₂₂alkoxy, C₂₋₂₂alkenyl, C₆₋₁₄aryl, C₆₋₂₂alkyl-substituted aryl and C₆₋₂₂arlalkyl which groups may be halogenated, for example, fluorinated to contain fluorocarbons such as C₁₋₂₂ fluoroalkyl, or may contain amino groups to form aminoalkyls, for example aminopropyl or aminoethylaminopropyl, or may contain polyether units of the formula (CH₂CHR⁶O)ₖ where R⁶ is CH₃ or H and k is in a range between about 4 and 20; and Z, independently at each occurrence, represents organic radicals containing epoxy group.

Silicone epoxy monomers made by heterogenous catalysis, such as MeMe for example, were blended with various antioxidants and stabilizers prior to reaction with a hydrogenated phthalic anhydride hardener and catalyst. The resulting epoxide/anhydride mixture was cured in two steps: one half hour at 100° C. and three hours cure at 150° C. The materials cured with retention of optical transparency exhibiting transmission at 400 nm of 88%. The epoxide mixtures could also be cured without addition of the hardener using a transparent catalyst such as 0.01-0.05 wt % of the thermally curing catalyst, 3-methyl-2-butenyltetramethylene sulfonium hexafluoroantimonate. The catalyst and formulation were blended at room temperature for approximately one half hour after which time the formulation was degassed at room temperature for 20 minutes. Cure of the transparent and clear blended composition in disk form was accomplished in two stages, first curing at 30 minutes at 90° C. for approximately one half hour and then final cure was achieved after a 2 hour cure was performed at 130° C. The molded disk was exposed to UV flux from an argon laser at 406 nanometers (nm) at approximately 300 milliwatts for 24 hours. The decrease in transmission was less than 2% versus initial measurements. Exposing the cured epoxy formulations to an ultraviolet (UV) flux greater than 0-10 times that emitted from UV or blue LEDs showed material of the present invention exhibited greater than 10% improvement of optical transmission versus typical LED encapsulants such as cycloolefin polymers and copolymers. Optical transmission was measured by utilizing a Macbeth Spectrophotometer. Another important use from the longer siloxane chain containing MeMe derivatives is to serve as a more flexible phosphor binder than can be achieved by the parent MeMe alone. The decrease in modulus of the 1,3-bis(1,2-epoxy-4-cyclohexylethyl)-1,1,2,2,3,3-hexamethyldisiloxane material for example versus MeMe allows better performance in thermal shock testing (cycling between 100° C. and −40° C. every fifteen minutes) since the material has greater flexibility that helps decrease effects of CTE mismatch between the chip, wire bonds, and polymer materials.

Although the invention has been described with reference to the exemplary embodiments, various changes and modifications can be made without departing from the scope an spirit of the invention. These modifications are intended to fall within the scope of the invention, as defined by the following claims.

1. An encapsulant composition comprising:
a. an epoxy including at least two siloxane repeat units, and
b. a curing agent.

2. The composition of claim 1 wherein said epoxy comprises 1,3-bis(1,2-epoxy-4-cyclohexylethyl)-1,1,3,3-tetramethyldisiloxane.

3. The composition of claim 1 wherein said composition is comprised of between about 2 and about 15 repeat (H₃C)₂ SiO units.

4. The composition of claim 3 wherein said units are substituted.

5. The composition of claim 4 wherein said siloxane repeat units are substituted with functional groups selected from the group consisting of cycloaliphatic groups, cycloaliphatic epoxy groups, glycidoxy groups, and mixture thereof.

6. The composition of claim 1 wherein said curing agent is selected from the group consisting of resins obtained by the condensation or co-condensation of phenols and naphthols with aldehydes, aralkyl phenolic resins, amines, amides, phenols, thiols, carboxylic acids, carboxylic anhydrides, and mixtures thereof.

7. The composition of claim 1 further comprising a filler having a particle size less than about 400 nm and selected from the group consisting of non-conductive carbon; powders of fused silica, crystalline silica, alumina, zircon, calcium silicate, calcium carbonate, silicon carbide, boron nitride, beryllia, zirconia; single-crystal fibers of potassium titanate, silicon carbide, silicon nitride, alumina; glass fibers; inorganic fillers having a flame retardant effect, and mixtures thereof.

8. The composition of claim 1 further including a coupling agent.

9. The composition of claim 8 wherein said coupling agent is selected from the group consisting of vinyltrichlorosilane, vinyltriethoxysilane, vinyltris(β-methoxyethyoxy) silane, γ-methacryloxypropyltiimethoxysilane, β-(3,4-epoxydicyclohexyl)ethyltrimethoxysilane, γ-glycidoxypropyltrimethoxysilane, vinlytriacetoxysilane, γ-mercaptopropyltirmethoxysilane, γ-aminopropyltriethoxysilane, y-[bis-(β-hydroxyethyl)] amino-propyltriethoxysilane, N-β-(aminoethyl)-γ-aminopropyltrimethoxysilane, γ-(β-aminoethyl)aminopropyldimethoxymethylsilane, N-(trimethoxysiliylpropyl) ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltriethoxysilaen, vinyltrimethoxysilane and γ-mercaptopropylmethyldimethoxysilane, isopropyltriisosteroyl titanate, isopropyltris(diocyl pyrophosphate) titanate, isopropyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isoprpyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisoprpylbis (dioctyl phosphite) titanate; and mixtures thereof.

10. A method for forming an encapsulant composition comprising the step of combining:
a. an epoxy including at least two repeat siloxane units, and
b. a curing agent.

11. A light emitting device comprised of a light emitting diode at least partially encapsulated by an epoxy composition including at least two repeat siloxane units.

12. The device of claim 11 wherein said epoxy composition includes between about 2 and about 15 repeat (H₃C)₂ SiO units.

13. The device of claim 12 wherein said repeat units are substituted.

14. The device of claim 13 wherein said repeat units are substituted with functional groups selected from the group consisting of cycloaliphatic groups, cycloaliphatic epoxy groups, glycidoxy groups, and mixture thereof.

15. The device of claim 11 wherein said epoxy composition further comprises a curing agent selected from the group consisting of resins obtained by the condensation or co-condensation of phenols and naphthols with aldehydes, aralkyl phenolic resins, amines, amides, phenols, thiols, carboxylic acids, carboxylic anhydrides, and mixtures thereof.

16. The device of claim 11 wherein said epoxy composition further comprises a filler having a particle size below about 400 nm and selected from the group consisting of non-conductive carbon; powders of fused silica, crystalline silica, alumina, zircon, calcium silicate, calcium carbonate, silicon carbide, boron nitride, beryllia, zirconia; single-crystal fibers of potassium titanate, silicon carbide, silicon nitride, alumina; glass fibers; inorganic fillers having a flame retardant effect, and mixtures thereof.

17. The device of claim 11 wherein said epoxy composition further comprises a coupling agent.

18. The device of claim 17 wherein said coupling agent is selected from the group consisting of vinyltrichlorosilane, vinyltriethoxysilane, vinyltris(β-methoxyethyoxy) silane, γ-methacryloxypropyltrimethoxysilane, β-(3,4-epoxydicyclohexyl)ethyltrimethoxysilane, γ-glycidoxypropyltrimethoxysilane, vinlytriacetoxysilane, γ-mercaptopropyltirmethoxysilane, γ-aminopropyltriethoxysilane, γ-[bis-(β-hydroxyethyl)] amino-propyltriethoxysilane, N-β-(aminoethyl)-γ-aminopropyltrimethoxysilane, γ-(β-aminoethyl)aminopropyldimethoxymethylsilane, N-(trimethoxysiliylpropyl) ethylenediamine, N-(dimethoxysilylisopropyl)ethylenediamine, methyltrimethoxysilane, methyltriethoxysilane, n-β-(N-vinylbenzylaminoethyl)-γ-aminopropyltrimethoxysilane, γ-chloropropyltrimethoxysilane, hexamethyldisilane, γ-anilinopropyltrimethoxysilaen, vinyltrimethoxysilane and γ-mercaptopropylmethyldimethoxysilane, isopropyltriisosteroyl titanate, isopropyltris(diocyl pyrophosphate) titanate, isopropyltri(N-aminoethyl-aminoethyl)titanate, tetraoctylbis(ditridecyl phosphite) titanate, tetra(2,2-diallyloxymethyl-1-butyl)bis(ditridecyl)phophite titanate, bis(dioctyl pyrophosphate) oxyacetate titanate, bis(dioctyl pyrophosphate) ethylene titante, isopropyltrioctanoyl titante, isoprpyldimethacrylisostearoyl titante, isopropyltridodecylbenzenesulfonyltitanate, isopropylisostearoyldiacryl titanate, isopropyltri(dioctyl phosphate) titanate, isopropyltricumylphenyl titanate and tetraisoprpylbis (dioctyl phosphite) titanate; and mixtures thereof.

19. The device of claim 111 further comprises a phosphor.

20. A lamp comprised of a light emitting diode at least partially surrounded by an encapsulant composition comprised of an epoxy composition including greater than two siloxane repeat units.
